(19) United States
(12) Patent Application Publication
(10) Pub. No.: US 2025/0044410 A1
(43) Pub. Date: Feb. 6, 2025

(54) PEAK-TO-AVERAGE POWER RATIO REDUCTION IN COMBINED RADAR AND COMMUNICATION SYSTEMS

(71) Applicant: ISTANBUL MEDIPOL UNIVERSITESI TEKNOLOJI TRANSFER OFISI ANONIM SIRKETI, Beykoz, Istanbul (TR)

(72) Inventors: Ebubekir MEMISOGLU, Beykoz, Istanbul (TR); Hüseyin ARSLAN, Beykoz, Istanbul (TR)

(21) Appl. No.: 18/717,070

(22) PCT Filed: Dec. 7, 2022
(86) PCT No.: PCT/TR2022/051434

§ 371 Date: Jun. 6, 2024

(30) Foreign Application Priority Data
Dec. 7, 2021 (TR) 2021/019284

(51) Int. Cl. G01S 7/40; G01S 7/00; H04L 27/26

(52) U.S. Cl. CPC G01S 7/4013; G01S 7/006; G01S 7/40; H04L 27/2621

(57) ABSTRACT

Disclosed is a method of reducing the Peak-to-Average Power Ratio (PAPR) for signals produced by both systems when radar and communication systems are located on the same hardware. The method has significant potential in improving the performance of the system and reducing hardware costs, especially in autonomous vehicles that use simultaneous radar and communication signals.

### TECHNICAL FIELD

The present invention relates to a method of reducing the Peak-to-Average Power Ratio (PAPR) for signals produced by both systems when radar and communication systems are located on the same hardware.

### STATE OF THE ART

In 4th Generation (4G) and 5th Generation (5G) cellular communication standards, orthogonal frequency division multiplexing (OFDM) is used as a waveform. Although this waveform has a particularly good spectral efficiency, one of its major disadvantages is its high Peak-to-Average Power Ratio (PAPR) value. In the literature, there are techniques developed to solve this problem, but these techniques cause losses in communication performance.

Radar systems generally have two different scenarios, monostatic and bistatic. In the monostatic scenario, the receiver and the transmitter are in the same hardware, while in the bistatic scenario, they are in different hardware. Therefore, for detection in monostatic radar systems, a radio signal is generated, transmitted to the channel, and then received by the transmitter in the same hardware. Many different waveforms have been developed for radar systems in order to increase detection performance in the literature. One of the biggest disadvantages of radar systems is the interference signals from other users. Orthogonal resources should be allocated to different users to prevent interference. This is possible in synchronous networks.

Prior to the invention, technical studies were being developed on resource management and channel access problems in general, in combination with radar and communication systems. The method according to the invention, unlike these approaches, proposes a way to reduce the PAPR value in the combination of radar and communication systems.

Many techniques have been developed to reduce the PAPR value in communication systems. Especially since the OFDM waveform has a disadvantage in terms of PAPR and is used with standards such as 4G and 5G, most of the studies in the literature try to reduce the PAPR value of the OFDM waveform. OFDM waveform PAPR reduction techniques can be classified under three headings: (i) signal degradation, (ii) multiple signaling and probability, and (iii) coding techniques. The method according to the invention is excluded from this classification as it does not make any changes in the communication waveform.

Radar signal adjustment techniques have been developed in order to increase the interference resistance in radar systems and to provide radar-sensing security. For this, radar signals called noise radar has been developed. Since the generated radar signal is random and known by the joint radar-communication transceiver, detection security against other users and reducing the effects of interference signals is possible. In addition, studies on reducing the interference effects and providing detection security in linear continuous wave radars are also carried out with different phase or frequency adjustments. The method according to the invention differs from such radar techniques in that the radar signal is adjusted according to the communication signal.

Considering the state of the art, it is seen that there is a need for methods that can reduce the distortions caused by power amplifiers by reducing the PAPR value of the total signal, both for monostatic radar systems and in combination with radar and communication systems, and accordingly, to reduce the necessary power amplifier hardware costs.

### OBJECTS AND BRIEF DESCRIPTION OF THE INVENTION

With the present invention, the inventors intend to develop a method that will ensure that the sum of the radar and communication signals has a low PAPR value by adjusting the radar signal in combination with the radar and communication systems. In this way, it is intended to increase energy efficiency by reducing the PAPR value for both systems without any performance loss.

Moreover, with the method of the invention, it is intended to have the advantages of low PAPR value, resistance to interference, and detection security for radar systems.

One of the important objects of the invention is to meet the radar requirements on the one hand, and on the other hand, ensure that the radar and communication signals have a low PAPR value without causing an extra performance loss.

The invention relates to a method for reducing PAPR values in combination with radar and communication systems, and the said method comprises the following steps:
Generating the communication signal.
Generating the radar signal.
Calculating the amplitude and phase values required to reduce the PAPR value of the communication and radar total signals.
Adjusting the radar signal with the calculated amplitude and phase values.
Collecting the communication and radar signals and sending them to the channel by passing them through the power amplifier.

### DESCRIPTION OF THE FIGURES

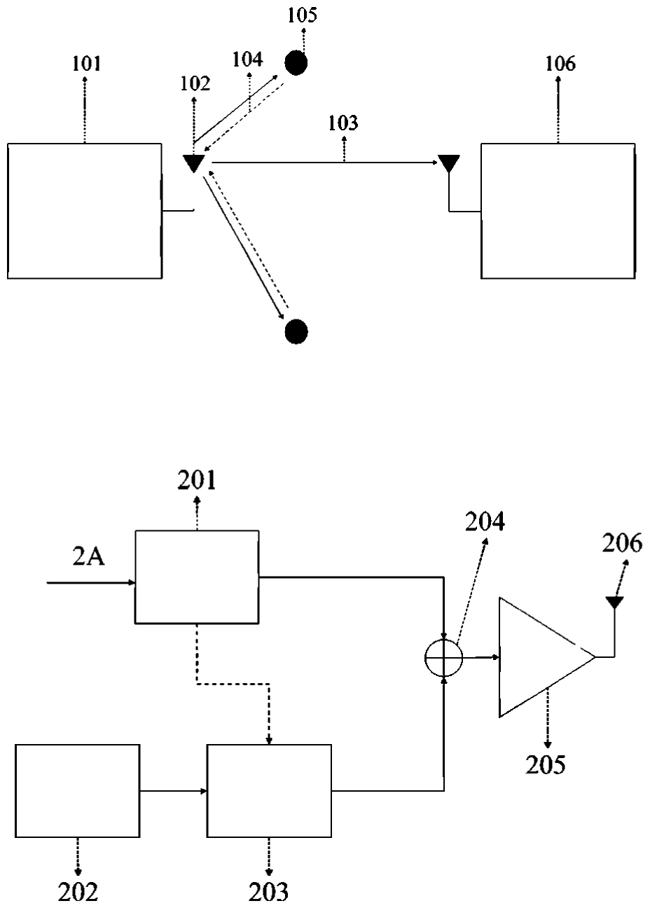

FIG. 1: The default system model for the invention
101: Joint radar-communications receiver
102: Antenna
103: Total transmitted radar and communication signal
104: Reflected signal
105: Object to be detected
106: Communication receiver

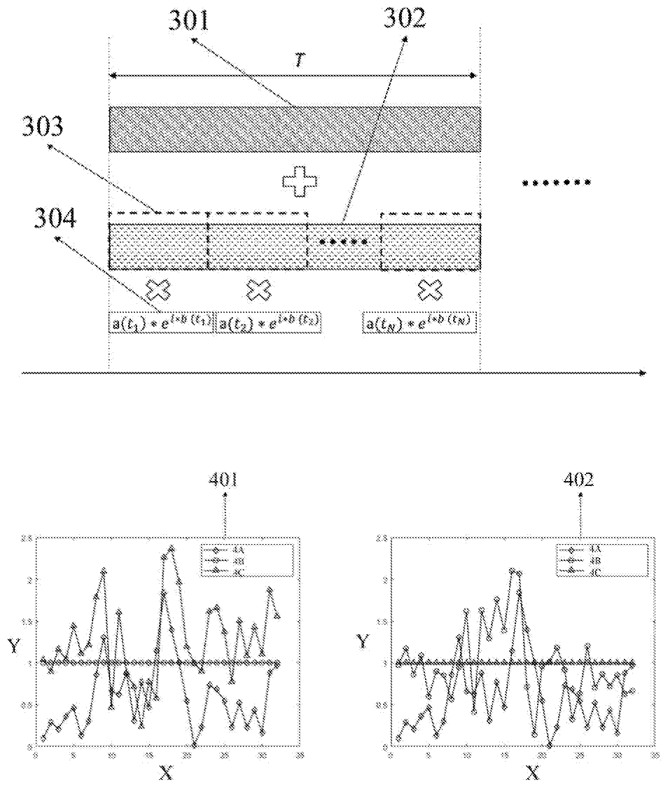

FIG. 2: Block diagram describing the invention
201: Communication Signal
202: Radar Signal
203: PAPR reduction-based adjustment
204: Signal collector
205: Power amplifier
206: Antenna
2A: Bits transmitted

FIG. 3: The PAPR in FIG. 2 shows a detailed explanation of the reduction-based adjustment process.
301: Communication signal
302: Radar signal
303: Radar signal segment
304: PAPR reduction-based adjustment factor
T: Time

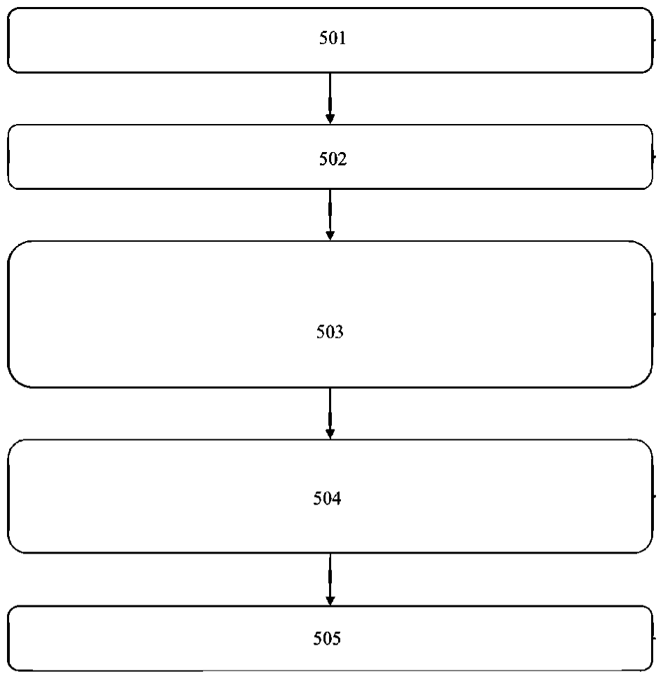

FIG. 4: Examples of the method according to the invention
401: Conventional method
402: Method according to the invention
4A: Communication Signal
4B: Radar Signal
4C: Total Signal
X: Time examples
Y: Amplitude absolute value

FIG. 5: Flow chart showing the necessary method steps for the invention
501: Generating the communication signal.
502: Generating the radar signal
503: Calculating the amplitude and phase values required to reduce the PAPR value of the communication and radar total signals
504: Adjusting the radar signal with the calculated amplitude and phase values
505: Collecting the communication and radar signals and sending them to the channel by passing them through the power amplifier

### DETAILED DESCRIPTION OF THE INVENTION

As mentioned above, the invention relates to a method for reducing PAPR values in combination with radar and communication systems, and the said method comprises the following steps:
Generating the communication signal (501).
Generating the radar signal (502).
Calculating the amplitude and phase values required to reduce the PAPR value of the communication and radar total signals (503).
Adjusting the radar signal with the calculated amplitude and phase values (504).
Collecting the communication and radar signals and sending them to the channel by passing them through the power (505).

FIG. 1 shows the default system model for the invention. The system model consists of a joint radar-communications transceiver (101), antenna (102), Total transmitted radar and communication signal (103), reflected signal (104), object to be detected (105), and the communication receiver (106). In the joint radar-communications receiver (101), different waveforms are generated for the radar and communication systems. OFDM for communication and the linear continuous wave (LCW) forms for radar is widely used in practice. Other waveforms may also be used for the invention. Both systems use bands separated from each other in the frequency space. In addition, signals are transmitted simultaneously. Therefore, the orthogonal coexistence of radar and communication systems is achieved by using different frequency sources. Here, the orthogonal coexistence of the two systems can also be provided for a different source, excluding the time source. In other words; the two systems must share the time in common at the same time, therefore, the systems can provide orthogonal coexistence at a source different from the frequency provided that this condition is met. In this system, the communication system aims to send data, on the other hand, the radar system aims to detect objects around it monostatically.

FIG. 2 shows the block diagram of the invention. As seen in the figure, the diagram of the invention consists of the communication signal (201), radar signal (202), PAPR reduction-based adjustment (203), signal collector (204), power amplifier (205), and antenna (206) parts. It is assumed that all the necessary digital and analog processing to generate the waveform is done in the communication signal (201) block; thus, the communication signal in time is denoted by x(t). In the same way, the radar signal is denoted by c(t), assuming that all necessary digital and analog processing is done in the radar signal (202) block. In the PAPR reduction-based adjustment (203) block, the necessary amplitude and phase changes for the radar signal is calculated by looking at the communication signal. These changes are generally made as a(t)*e\hat{ }(b(t)). Here, a(t) and b(t) denote changes in the amplitude and phase of the signal over time, respectively. Therefore, the signal obtained as a result of PAPR reduction-based adjustment (203) to the radar signal (202) c(t) is a(t)*c(t)*e\hat{ }(b(t)). Then, the communication signal and the PAPR reduction-based adjusted radar signal are collected by the signal collector (204) to obtain y(t)=x(t)+a(t)*c(t)*e\hat{ }(b(t)). The power amplifier (205) amplifies this signal and sends it to the channel via an antenna (206). During this amplification, the PAPR value of the y(t) signal determines the performance efficiency of the power amplifier (205). The PAPR value of the signal is calculated as PAPR(y(t))=max(|y(t)|\hat{ }(2))/E(|y(t)|\hat{ }(2)). Here, time (t) denotes an instant of time such as 0≤t≤5 T in the selected time period (T). In addition, max(.) and E(.) functions calculate the maximum value of the signal power and the average signal power for the range 0≤t≤T, respectively. The chosen time (T) is usually taken to be equal to the total symbol length of the communication signal.

FIG. 3 shows the PAPR reduction-based adjustment (202) process in detail. FIG. 3 consists of the communication signal (301), radar signal (302), radar signal segment (303), and PAPR reduction-based adjustment factor (304). The purpose here is to minimize the PAPR value of the total signal by adjusting the radar signal. This adjustment may precisely cause the performance of the radar systems to decrease. However, radar signal adjustments without considering PAPR reduction are common in the literature. Radar signal adjustment techniques in the literature are used to increase the resistance against interference caused by other radars and to provide detection security. Therefore, the invention proposes that the PAPR of the total signal can be reduced while meeting these radar requirements. For this, the radar signal (302) at the chosen time T is divided into N segments. Here, the time T is taken as the total symbol length in the communication system, and each radar signal segment (Figure (303)) is represented by dashed rectangles. The amplitude and phase changes to each of these radar signal segments (303) are expressed by the adjustment factor (304). This factor is calculated by the PAPR reduction-based adjustment (202) block, looking at the communication signal (301). Here, the time interval of the nth radar signal segment (303) is taken as t(n−1)<t_(n)≤t_(n+1). The factors are calculated as follows:

$$[ a ( t\_ ( n ) ) , b ( {t}_{-} ( n ) ) ] = min\_ \{ α ( t\_ ( n ) ) , β ( t\_ ( n ) ) \} ( x ( t\_ ( n ) ) + α ( t\_ ( n ) ) * c ( t\_ ( n ) ) * {e}^{∧} ( β ( t\_ ( n ) ) ) ) \qquad ( Formula 1 )$$

where the function min_{α(t_(n)), β(t_(n))}(.) finds the values of α(t_(n)) and β(t_(n)) that minimize the expression. These calculated values are then assigned to a(t_(n)) and b(t_(n)) values, respectively. After these values are calculated, the nth (n=1,2, . . . ,N) radar signal segment is adjusted as a(t_(n))*c(t_(n))*e\hat{ }(b(t_(n))). The adjusted radar signal and communication signal (301) are then collected. FIG. 4 shows two examples for a better understanding of this method. In the so-called conventional method (401), the sum of the communication signal and the radar signal worsens the PAPR performance. If a different amplifier were used for both systems, only the communication signal would have the PAPR problem. In the case that the invention is suitable (402), even if the PAPR performance of both signals were poor, the PAPR performance of the total signal would be exceptionally good. In the invention, it is suggested to use a power amplifier for both systems. Therefore, this can help reduce hardware costs.

In brief; step 501 is described in detail with 201 and 301. Step 502 is described in detail with 202 and 302. Step 503 is described in detail with 304. Step 504 is described in detail with 203 and 303. Step 505 is described in detail with 204.

The technical and all other features mentioned in each claim are followed by a reference number, these reference numbers are used only for a better understanding of the claims, therefore, they should not be considered as limiting the scope of any of the elements indicated by these reference numbers for illustrative purposes.

Within these basic concepts, it is possible to develop a wide variety of embodiments of the subject matter of the invention, and the invention cannot be limited to the examples described herein but is essentially as set forth in the claims.

It is clear that those skilled in the art can demonstrate the innovation revealed in the invention by using similar embodiments and/or can apply this embodiment to other similar fields used in the related art. Therefore, it is obvious that such embodiments will lack the criteria of innovation and especially of exceeding the state of the art.

### INDUSTRIAL APPLICABILITY

The invention can be implemented in devices with joint radar-communication systems, using the radar signal using digital and/or analog processes as in the invention. The invention does not require a change in communication standards and has the potential to be applied especially to autonomous vehicles.

1. A method for reducing PAPR values in combination with radar and communication systems, the method comprising:
generating a communication signal (501);
generating a radar signal (502);
calculating amplitude and phase values required to reduce the PAPR value of the communication and radar total signals (503);
adjusting the radar signal with the calculated amplitude and phase values (504); and
collecting the communication and radar signals and sending them to the channel by passing them through a power amplifier (505).

2. The method of claim 1, wherein OFDM waveform is used for communication.

3. The method of claim 1, wherein linear continuous wave (LCW) form is used for radar.

4. The method of claim 1, wherein the radar is monostatic or bistatic.

5. The method of claim 4, wherein the radar is a monostatic radar.

6. The method of claim 1, wherein in step 501, the communication signal is denoted by x(t), assuming that all digital and analog operations necessary for the generation of the waveform in the communication signal block have been performed.

7. The method of claim 1, wherein in step 502, the radar signal is denoted by c(t), assuming that all the necessary digital and analog operations have been performed in the radar signal block.

8. The method of claim 1, wherein the process of calculating (503) the amplitude and phase values required to decrease the PAPR value of the communication and radar total signals, and adjusting (504) the radar signal with the calculated amplitude and phase values comprise the steps of:
obtaining radar signal segments by dividing the radar signal of the selected duration T into N segments, where T is the total symbol length in the communication system;
calculating the adjustment factor, which expresses the amplitude and phase change to each radar and signal segment, by the PAPR reduction-based adjustment block, looking at the communication signal and using the formula I,
$$[ a ( t\_ ( n ) ) , b ( {t}_{-} ( n ) ) ] = min\_ \{ α ( t\_ ( n ) ) , β ( t\_ ( n ) ) \} ( x ( t\_ ( n ) ) + α ( t\_ ( n ) ) * c ( t\_ ( n ) ) * {e}^{∧} ( β ( t\_ ( n ) ) ) ) \qquad ( Formula 1 )$$
finding the values of α(t_(n)) and β(t_(n)) that minimize the equation in the function min_{α(t_(n)), β(t_(n))}(.) in Formula 1;
assigning α(t_(n)) and β(t_(n)) values calculated in the previous step to a(t_(n)) and b(t_(n)) values, respectively,
setting the nth (n=1,2, . . . ,N) radar signal fragment as a(t_(n))*c(t_(n))*e\hat{ }(b(t_(n))) after value assignment; and
obtaining the communication signal and the PAPR reduction-based adjusted radar signal as y(t)=x(t)+a(t)*c(t)*e\hat{ }(b(t)) by collecting them with the signal collector.

9. The method of claim 8, wherein the changes in the radar signal are used to solve a different problem in radar and communication systems.

10. The method of claim 9, wherein changes in the radar signal are used to reduce the out-of-band emission (OOBE) of radar and communication systems.

11. The method of claim 1, wherein it is used to improve system performance in autonomous vehicles using simultaneous radar and communication signals.
